(19) United States
(12) Patent Application Publication
(10) Pub. No.: US 2020/0355597 A1
(43) Pub. Date: Nov. 12, 2020

(54) AUTOMATED AIRBORNE PARTICULATE MATTER COLLECTION, SAMPLING, IMAGING, IDENTIFICATION, MEASURING, AND ANALYSIS SYSTEM

(71) Applicant: Pollen Sense LLC, Provo, UT (US)

(72) Inventors: Nathan Allan, Mapleton, UT (US); Kevn Lambson, Lewis, CO (US); Richard Lucas, Phoenix, AZ (US); Landon Bunderson, Springville, UT (US)

(73) Assignee: Pollen Sense LLC, Provo, UT (US)

(21) Appl. No.: 16/872,278

(22) Filed: May 11, 2020

Related U.S. Application Data
(60) Provisional application No. 62/846,320, filed on May 10, 2019.

(51) Int. Cl. G01N 15/06; G01N 15/02; G02B 21/36

(52) U.S. Cl. CPC G01N 15/0618; G02B 21/361; G01N 15/0205; G01N 15/0612

(57) ABSTRACT

An air sampling device for collecting and analyzing airborne particulate matter. The air sampling device may include a housing, an air intake aperture in the housing where air enters an interior of the housing, a collection surface, disposed within the housing, that captures airborne particulate matter contained in the air, and an imaging device that captures an image of the airborne particulate matter collected on the collection surface. The device may also include a microscope for viewing the airborne particulate matter collected on the collection surface. The imaging device captures an image of the airborne particulate matter collected on the collection surface. The imaging device views and captures an image of the airborne particulate matter collected on the collection surface through the microscope.

### CROSS REFERENCE TO RELATED APPLICATIONS

This application claims the benefit of U.S. Provisional Patent Application No. 62/846,320, filed May 10, 2019, titled “AUTOMATED AIRBORNE PARTICLE SAMPLING SYSTEM,” which is incorporated herein by reference in its entirety, including but not limited to those portions that specifically appear hereinafter, the incorporation by reference being made with the following exception: In the event that any portion of the above-referenced provisional application is inconsistent with this application, this application supersedes said above-referenced provisional applications.

### TECHNICAL FIELD

The present disclosure relates generally to sampling, measuring, and identifying airborne particulate matter and more particularly relates to systems, methods, and devices for collecting, sampling, imaging, identifying, measuring, and analyzing airborne particulate matter.

### BACKGROUND

Ambient air, both indoors and outdoors, includes aerosols/airborne particulate matter. This airborne particulate matter may include dust, pollen, chemical particles, pollutants, and various other elements, particles, and/or compounds that may be organic, naturally-occurring, or synthetic. Some of these airborne materials may be harmful to humans that breathe such materials into their respiratory systems. Airborne particulates have been linked to detrimental health effects in humans. For example, airborne particulates are known to aggravate respiratory illnesses and have led people to be hospitalized for allergies, asthma, difficulty breathing, and other respiratory difficulties.

Short-term exposure (minutes, hours, or days) to certain airborne particulate matter or elevated levels of airborne particulates may cause aggravation of allergies, asthma, and other respiratory difficulties in human beings. Longer term exposures, over several years or decades, to elevated levels of certain airborne particulate matter has even greater health risks and may affect bodily systems apart from the respiratory system. For example, long term exposure may permanently damage the respiratory system and may lead to greater risk of heart disease and other chronic, possibly incurable conditions.

Additionally, airborne particulate matter may have significant harmful effects on plants and animal life, and is, therefore, significantly important to consider for its environmental, horticultural, ecological, biological, and economic impacts, as well as the expansion of current scientific knowledge.

Certain airborne particulates have increased in prevalence in recent decades and new airborne particulates may also become present in the ambient air. Due to this increase, the prevalence of allergies, asthma, and other respiratory conditions and illnesses have also become more prevalent. Such trends and increases are forecasted to intensify with the passage of time.

The increase in respiratory illness due to increase in airborne particulate matter may be lessened by identifying types and levels of airborne particulate matter contained in the ambient air and formulating proper and effective mitigation strategies for reducing the levels of airborne particulate matter in the air. Additionally, diagnoses, medicines, and treatments can be improved by knowing what types and levels of airborne particulate matter are present in the ambient air. Accordingly, knowledge about types, levels, composition, concentration, and distributions of airborne particulate matter in the ambient air and environment can significantly lessen burdens on people, medical systems, governments, and economies caused by respiratory illness and aggravation of other related health conditions.

Air sampling devices have been developed. However, current air sampling devices are limited in their capability and reliability in collecting, measuring, and identifying several different types of airborne particulate matter. For example, certain current air sampling devices require the use of chemical solutions and agents in order to test the composition and concentration of airborne particulate matter, which complicates and slows down the process of particulate identification.

Other air sampling devices rely on light refraction for particulate identification. In other words, differences in how particulates refract light are used to identify which type of particulate is being observed. However, the use of light refraction to identify particulate matter does not adequately identify characteristics of shape, color, size, or other visual characteristics of particulate matter.

Furthermore, current methods and devices for identifying particulate matter only provide single-moment snapshots of the composition and concentration of airborne particulate matter in the ambient air. Current methods do not allow for continuous real-time sampling and continuous real-time imaging and identification of airborne particulate matter. Accordingly, current methods and devices fail to provide operations for identifying and documenting a change in composition and/or concentration of airborne particulate matter over a passage of time.

Because of the seriousness of detrimental effects airborne particulate matter can have on humans, plants, and the environment, there exists a need for quicker, simpler, more reliable, more efficient, and more detailed collection, measurement, identification, and analysis of the composition and concentration of airborne particulate matter in the ambient air. Additionally, systems and air sampling devices with the ability to identify more characteristics (e.g. color, size, shape, or other visual properties) of airborne particulate matter are needed. Therefore, it is desirable to develop an automated air sampling system, method, and device for sampling and identifying airborne particulate matter that allows for quicker, more detailed, and more reliable sampling and identification, and that provides continuous sampling and continuous imaging and identification of airborne particulate matter.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1A illustrates an example air sampling device according to one embodiment, including a collection surface subsystem, an imaging subsystem, and a particle capture chamber.

FIG. 1B illustrates a front view of an example air sampling device according to one embodiment.

FIG. 1C illustrates a top view of an example air sampling device according to one embodiment.

FIG. 2A illustrates an example collection surface and collection surface subsystem for driving movement of the collection surface within an example air sampling device according to one embodiment, including a collection surface, a feed spool, and an uptake spool.

FIG. 2B illustrates an exploded view of an example uptake spool of an example collection surface subsystem according to one embodiment.

FIG. 2C illustrates an exploded view of an example feed spool of an example collection surface subsystem according to one embodiment.

FIG. 3 illustrates an example imaging subsystem of an example air sampling device according to one embodiment including a microscope, an imaging device, and a translation stage for moving the microscope and imaging device.

FIGS. 4A-4K illustrate various views of a particle capture chamber subsystem of an example air sampling device according to one embodiment. FIGS. 4L and 4M illustrate an example optical cartridge of an example air sampling device according to one embodiment.

FIG. 5 illustrates an example configuration of a collection surface subsystem, imaging subsystem, and particle capture chamber subsystem of an example air sampling device according to an embodiment.

FIGS. 6A-6F illustrate an example air sampling device and example components according to one embodiment.

FIG. 7 illustrates a method of collecting and analyzing airborne particulate matter using an air sampling device.

FIG. 8 is a block diagram of an example computing device in accordance with the teachings and principles of the disclosure.

### DETAILED DESCRIPTION

Disclosed herein are systems, methods, devices, and computer-based products for the automated collection, sampling, imaging, identification, measuring, and analysis of airborne particulate matter in the ambient air. An embodiment of the disclosure is an air sampling device for collecting, analyzing, and identifying airborne particulate matter with an imaging device that captures an image of the airborne particulate matter. Such methods, systems, devices, and computer-based products disclosed herein provide for automated collection and identification of aerosols, airborne particulate matter, airborne substances, and the like in ambient air.

An embodiment of the disclosure is an air sampling device for collecting, analyzing, and identifying airborne particulate matter comprising a collection surface that captures airborne particulate matter contained in ambient air and an imaging device for capturing one or more images of airborne particulate matter collected on the collection surface. In an embodiment, the collection surface captures the airborne particulate matter using electrostatic attraction between the collection surface and the airborne particulate matter. In an embodiment, the collection surface captures the airborne particulate matter using adhesive materials or substances for, or on, the collection surface to hold particulate matter. In an embodiment, the air sampling device comprises an imaging device for capturing an image of particulate matter collected on the collection surface. In an embodiment, the air sampling device further comprises a microscope for viewing and enlarging the airborne particulate matter collected on the collection surface and the imaging device views and captures an image of the airborne particulate matter collected on the collection surface through the microscope.

In an embodiment, the air sampling device comprises an emitter that emits light onto the particulate matter collected on the collection surface at a point of image capture. In an embodiment, the collection surface is back-lit relative to a surface of the collection surface that faces the imaging device. Alternatively, in an embodiment, the collection surface is front-lit relative to a surface of the collection surface that faces the imaging device. In an embodiment, the emitter emits light onto the collection surface via a reflector that directs light emitted from the emitter onto the collection surface.

During imaging of the particulate matter by the imaging device, emitted light improves visibility and detail of the images captured by the imaging device and improves visibility of particulate matter captured in the image. The light emitted on to the collection surface and particulate matter may be light within a visible range of the electromagnetic spectrum or light within invisible ranges of the electromagnetic spectrum. The imaging device may be able to detect or capture light in both visible and invisible ranges of the electromagnetic spectrum. The use of the imaging device, microscope, and emitter allows for improved visibility and detail in captured images of airborne particulate matter. Therefore, detection, analysis, and identification of airborne particulate matter is also improved. In light of the foregoing, disclosed herein are multiple embodiments of a lighting and imaging a collection surface containing airborne particulate matter for increasing detail and visibility of airborne particulate matter on the collection surface.

In an embodiment of the air sampling device, the collection surface comprises a flexible tape. In an embodiment, the air sampling device comprises a feed spool and an uptake spool wherein: the collection surface is wound around the feed spool and extends from the feed spool to the uptake spool; as the collection surface is fed out from the feed spool, the collection surface passes an air intake aperture, collects airborne particulate matter entering through the air intake aperture, and is wound up around the uptake spool; and, as the collection surface travels from the feed spool to the uptake spool, an image of the airborne particulate matter captured on a portion of the collection surface disposed between the feed spool and the uptake spool is captured. In an embodiment, the collection surface continually collects airborne particulate matter along a length of the flexible tape as the collection surface moves from the feed spool to the uptake spool. In an embodiment, the collection surface continually collects airborne particulate matter along a length of the flexible tape as the collection surface moves from the feed spool to the uptake spool. In an embodiment, the imaging device repeatedly captures images of the collection surface and airborne particulate matter as the collection surface moves from the feed spool to the uptake spool.

Conventional air sampling devices are only capable of taking a single sample of ambient air for analysis and identification of airborne particulate matter. In such conventional air sampling devices, each sample must be captured, analyzed, and disposed of before another sample can be collected and analyzed. Additionally, in certain conventional endoscopes, chemicals, agents, and compounds used to identify particulate matter must be disposed of and replaced before another sample may be collected and analyzed. Accordingly, there is a desire for an air sampling device that can continually take samples automatically over an elapse of time and continually image said samples over time for analysis and identification of airborne particulate matter contained in the samples. In light of the foregoing, disclosed herein are multiple embodiments of an air sampling device for continually collecting and imaging ambient air and airborne particulate matter samples.

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the structure, systems, devices, and methods for automated air sampling and identification of airborne particulate matter are disclosed and described, it is to be understood that this disclosure is not limited to the particular structures, configurations, process steps, and materials disclosed herein as such structures, configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element or step not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

A detailed description of systems and methods consistent with embodiments of the present disclosure is provided below. While several embodiments are described, it should be understood that this disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments may be practiced without some or all of these details. Moreover, for the purpose of clarity, certain technical material that is known in the related art has not been described in detail in order to avoid unnecessarily obscuring the disclosure.

This disclosure uses the term “emitter” to mean a device that is capable of generating and emitting electromagnetic radiation. Electromagnetic radiation emitted by an emitter may comprise wavelengths from both the visible and non-visible ranges of the electromagnetic spectrum. An emitter may produce a steady stream of electromagnetic radiation or may be pulsed on and off to emit intermittent pulses of electromagnetic radiation. An emitter may have variable power output levels or may be controlled with a secondary device such as an aperture or filter. An emitter may comprise a plurality of electromagnetic sources that act individually or in concert and may also comprise an emitter module comprising one or more electromagnetic radiation sources for pulsing electromagnetic radiation. An emitter is a light source that may be controlled digitally or through analog methods or systems.

It should be noted that the term “light” is intended to be used in this disclosure to denote electromagnetic radiation that may include wavelengths from the visible and non-visible portions of the electromagnetic spectrum. An emitter is a source of a burst of electromagnetic energy and includes light sources, such as lasers, LEDs, incandescent light, or any light source that can be digitally controlled.

As used herein, the terms “air” and “airborne” are not limited to breathable air or the common composition of the atmosphere. The terms “air” and “airborne” also include any gaseous medium, whether toxic or non-toxic, breathable or not, that may be tested for composition, concentration, or for particulate matter contained in the gaseous medium. Therefore, the terms “air” and “airborne” as used herein should not be seen as limiting and/or referring only to atmospheric air; the terms “air” and “airborne” may refer to any gaseous medium.

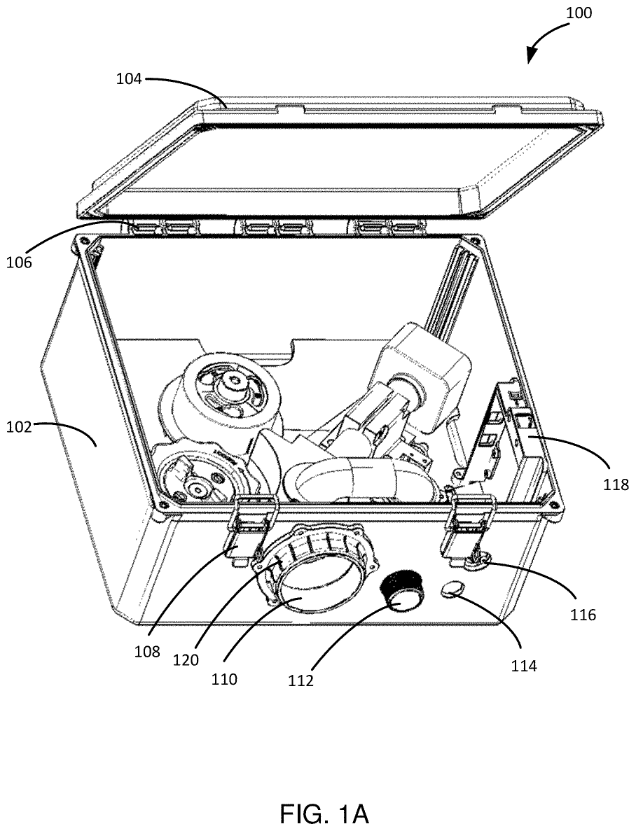

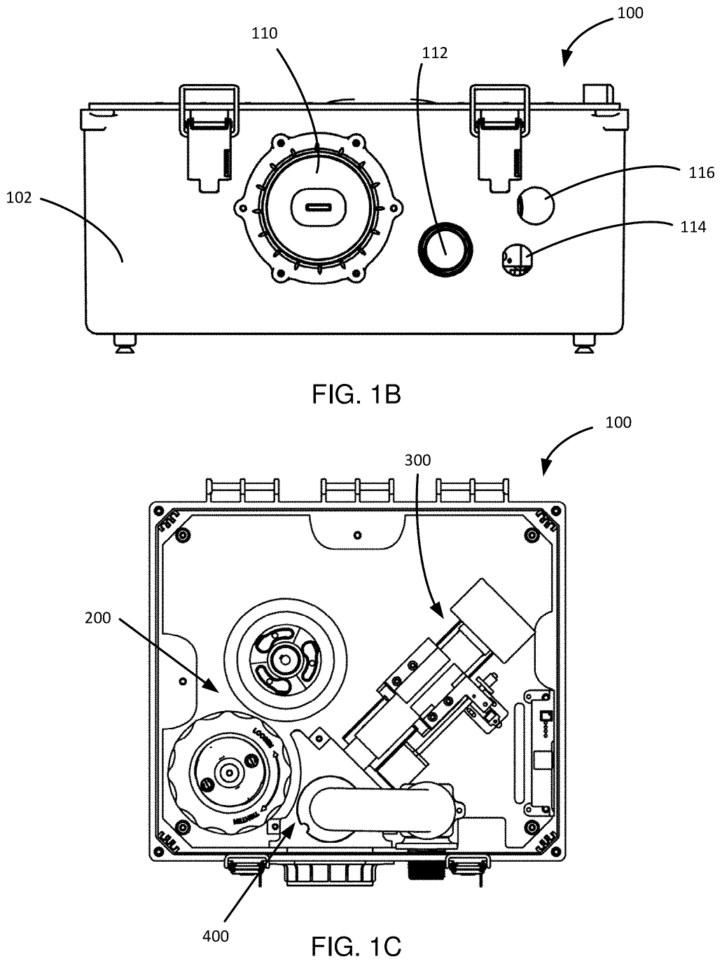

Turning to the figures, FIGS. 1A-1C are illustrations of an air sampling device 100 for the automated collection, analysis, and identification of airborne particulate matter. As shown in FIG. 1A, air sampling device 100 may include a housing 102 that houses various components and subsystems for the operation of air sampling device 100. The housing 102 may include a lid 104 attached to housing 102 by one or more hinges 106 that allow lid 104 to pivot between an opened state and a closed state. Housing 102 may further include fasteners 108 configured to secure lid 104 in a closed state.

Housing 102 may further include an air intake aperture 110, an air exhaust 112, an electrical port 114, and an internet access port 116, each formed through a surface of housing 102. Air intake aperture 110 allows ambient air to enter housing 102 of air sampling device 100 in order to sample the air for airborne particulate matter using the systems contained in housing 102. Air exhaust 112 expels air from the inside of housing 102. The air expelled from air exhaust 112 is air that has finished being sampled and may be returned to the ambient environment. Electrical port 114 allows for electricity to be supplied to air sampling device 100 and its various components in order to perform the automated sampling and analysis on air samples. Electrical port 114 may include any combination of wiring and connections known in the art that are suitable for providing power to an electrical system. Internet access port 116 is configured to provide air sampling device 100 with access to the internet, local area networks, or any other networks that may be used to transfer data. Internet access port 116 is not limited to wired connections. Internet access port 116 may provide for wireless receivers and transmitters that connect to wireless networks, Bluetooth, or any other known wireless methods of transferring data.

Housing 102 may further include controller housing 118 that houses a controller for executing computer-based instructions for performing the functions for each component and subsystem of air sampling device 100, including driving the components and subsystems, collecting data and analysis information from the air samples, identifying concentration, composition, and types of airborne particulate matter found in the samples, and storing and transmitting such data and information.

Housing 102 may further include an air intake collar 120 surrounding air intake aperture 110 to steady and/or secure air intake aperture 110 to housing 102. Additionally, an air intake gasket may be disposed between air intake collar 120 and housing 102 to seal housing 102 and prevent air from leaking out of air intake aperture 110.

FIG. 1B shows a front view of air sampling device 100 and provides additional views of housing 102, air intake aperture 110, air exhaust 112, electrical port 114, and internet access port 116. FIG. 1B further shows a nozzle aperture within air intake aperture. The nozzle aperture will be described in further detail below.

As shown in FIG. 1C, housing 102 contains various subsystems that each perform functions for collecting and imaging airborne particulate matter in ambient air samples. For example, air sampling device 100 may include a collection surface subsystem 200 that drives a collection surface along a desired path to collect airborne particulate matter in ambient air samples, an imaging subsystem 300 that views and images airborne particulate matter collected on the collection surface for analysis and identification, and a particle capture chamber subsystem 400 that intakes ambient air samples from an ambient environment outside of housing 102 and expels used air samples back to the ambient environment after airborne particulate matter has been collected from the air. Each of these subsystems will be described in detail below.

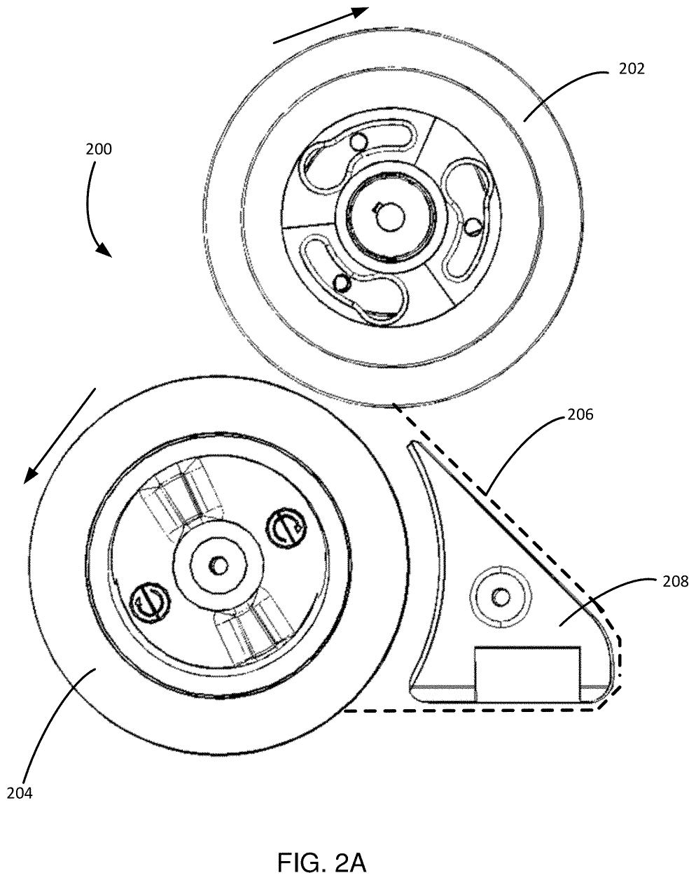

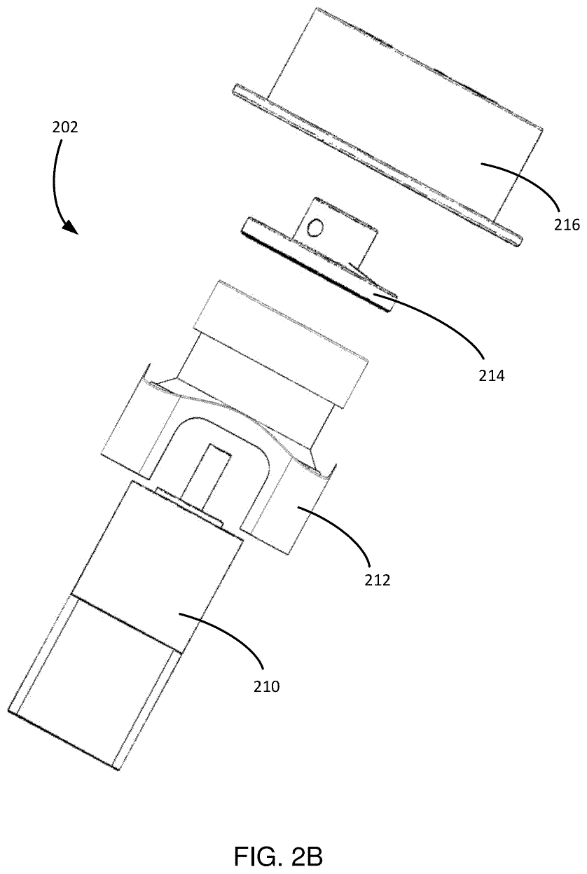

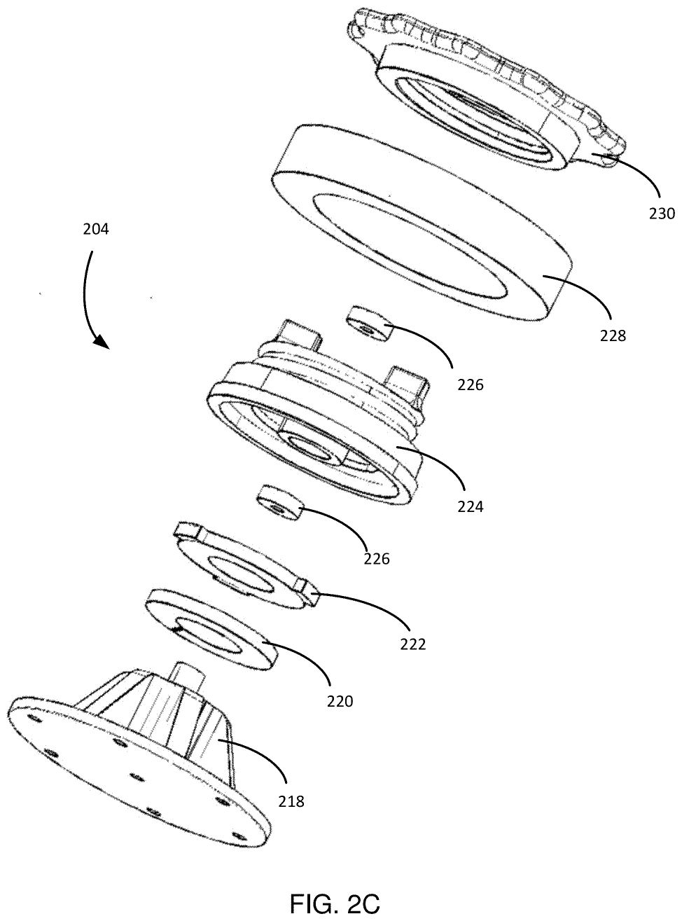

FIG. 2A illustrates collection surface subsystem 200. As shown, collection surface subsystem 200 includes an uptake spool 202, a feed spool 204 and a collection surface 206 (illustrated by a dotted line) that extends from feed spool 204 to uptake spool 202.

Collection surface 206 may be made of a flexible tape material that is suitable to be wound around a reel or spool and fed out by the spool. For example, the flexible tape material may be a silicone tape, metal tape, plastic tape, or any other suitably flexible material. Collection surface 206 may collect airborne particulate matter and adhere particulate matter to collection surface 206 by means of electrostatic attraction or by an adhesive material or substance applied to, or used as, collection surface 206. For example, a material may be chosen for collection surface 206 that exhibits electrostatically attractive properties to types of airborne particulate matter that are desired to be collected. Additionally, a material without electrostatically attractive properties may be used as collection surface 206 and a material or substance that does exhibit electrostatically attractive properties may be applied to collection surface 206. Similarly, an adhesive material may be used as collection surface 206, or an adhesive material or substance may be applied to collection surface 206 in order to attract and collect airborne particulate matter. Electrostatically-attractive and/or adhesive materials and/or substances may be applied to one or both sides of collection surface 206.

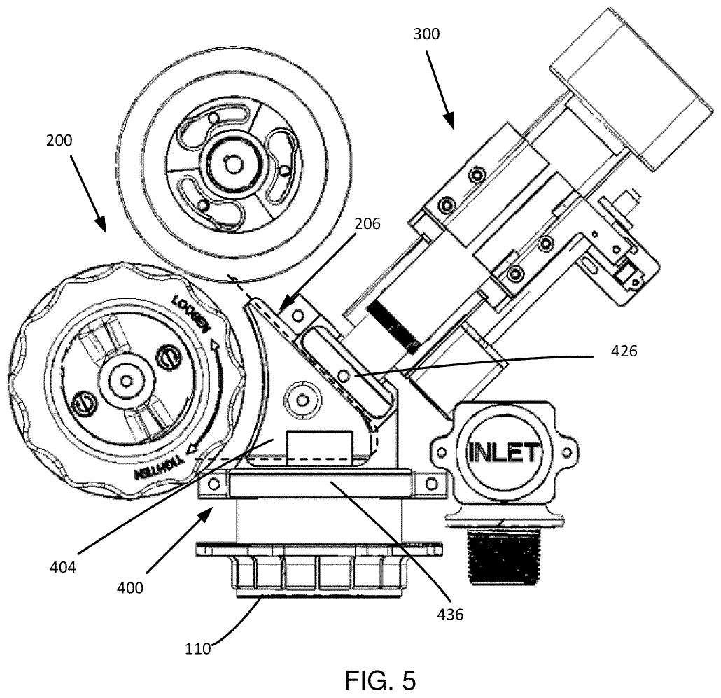

As shown in FIG. 2A, feed spool 204 rotates in a direction, for example counter-clockwise, in order to feed out collection surface 206. As collection surface 206 is fed out from feed spool 204, collection surface 206 passes air intake aperture 110 where ambient air is entering housing 102. As collection surface 206 passes air intake aperture 110, airborne particulate matter in the ambient air collects on collection surface 206 (see FIG. 5). Collection surface 206 then continues and wraps around guide member 208 as collection surface is fed out from feed spool 204 and is guided toward uptake spool 202. Before reaching uptake spool 202, collection surface 206 passes an imaging aperture (described below) and particulate matter collected on collection surface 206 is imaged by imaging subsystem 300. Uptake spool 202 rotates in a direction, for example clockwise, to wind up and collect collection surface 206 as it is fed out from feed spool 206. Guide member 208 corresponds to a part of particle capture chamber subsystem 400, which will be described in detail later.

As described above and shown in FIG. 2A, the collection surface subsystem 200 is a two-wheel cassette reel system comprising a feed spool 204 and an uptake spool 202. As shown in FIG. 2B, uptake spool 202 includes a motor 210, a motor housing 212, a connecting attachment 214, and a top wheel 216 removably secured to the motor via the connecting attachment. The motor 210 is configured to rotate top wheel 216. An end of collection surface 206 may be secured to top wheel 216 such that collection surface 206 reels off of feed spool 204 and winds around and is collected by top wheel 216 of uptake spool 202 as motor 210 rotates top wheel 216.

The feed spool 204 is configured to hold and support collection surface 206. As shown in FIG. 2C, feed spool 204 comprises a base 218, a main washer 220, an embedded circular feature 222, a clutch spring mechanism 224, bearings 226, a tape roll 228 of collection surface 206, and support wheel 230. The clutch spring mechanism 224 serves to facilitate controlled, passive rotation of the feed spool. Support wheel 230 is configured to hold and facilitate use of tape roll 228. The main washer 220 and bearings 226 are configured to facilitate rotational motion of the feed spool 204. Base 218 includes a center rod wherein a spring of clutch spring mechanism 224 is secured between the base 218 and the clutch spring mechanism 224. The center rod on base 218 is configured to vertically align the components of the feed spool 204.

Clutch spring mechanism 224 allows for collection surface 206 to be released in a uniform manner, wherein collection surface 206 is peeled from the tape roll 228 at a right angle to minimize aberrations, damage, and/or striations in the adhesive or collection surface 206 in order to ensure consistent and clear imaging results. The clutch spring mechanism 224 is also configured to allow for continuous rotation without the feed spool catching or sticking in an undesired way. Clutch spring mechanism 224 allows feed spool 204 to rotate freely while also providing for a back-spin release. The clutch spring mechanism 224 also provides a counter-weight effect as a constant force to ensure the tape does not drift during operation or imaging.

As motor 210 rotates top wheel 216 of uptake spool 202, collection surface 206 is unwound from tape roll 228 of feed spool 204. As shown in FIG. 2A, guide member 208 is configured and disposed to guide collection surface 206 across air intake aperture 110 so that incoming ambient air flows toward collection surface 206 to facilitate the collection of airborne particulate matter on collection surface 206. Furthermore, guide member 208 is configured and disposed to guide collection surface 206 in front of an imaging position of imaging subsystem 300 after airborne particulate matter collections on collection surface 206 in order to facilitate image capture of airborne particulate matter on collection surface 206.

After collection surface 206 passes the imaging position, the used portions of the collection surface 206 collect around the outer perimeter of the top wheel 216. When the collection surface 206 on tape roll 228 has run out, a user may easily detach the top wheel 216 and discard the used collection surface 206. A new tape roll 228 may be easily loaded onto feed spool 204 and sampling may continue in a quick, efficient, and easy manner.

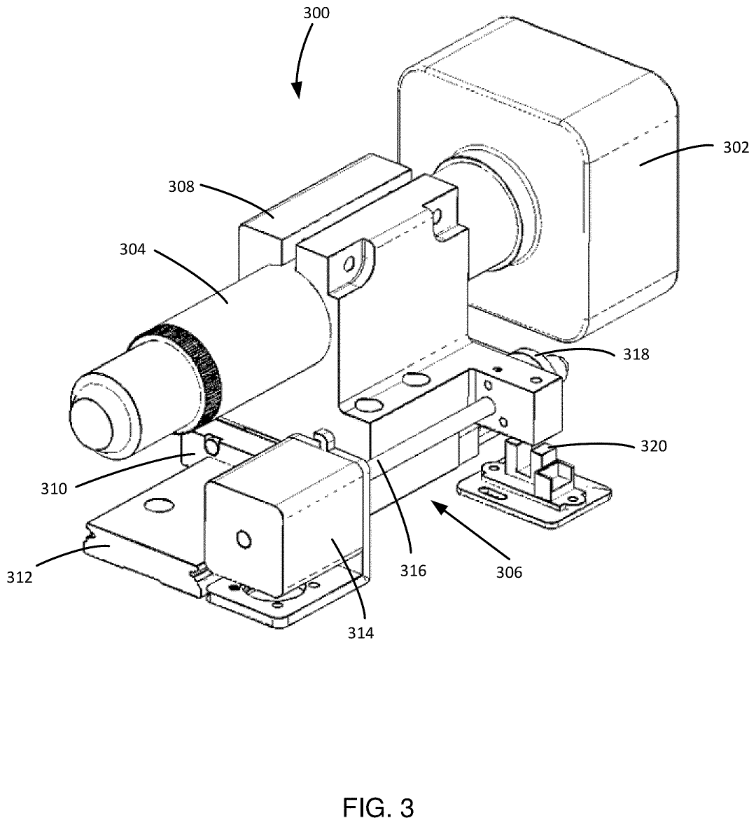

The imaging subsystem 300 of air sampling device 100 will now be described with reference to FIG. 3. As shown in FIG. 3, imaging subsystem 300 includes an imaging device 302 for capturing images of airborne particulate matter collected on collection surface 206 and a microscope 304 enlarging airborne particulate matter that is being captured. Imaging device 302 may be any image capturing device that captures images and is sensitive to either or both of visible and invisible electromagnetic radiation. Imaging device 302 may further include both still image capturing devices and video capturing devices. Either of still images or video may be used to image collection surface 206 and airborne particulate matter.

Imaging device 302 and microscope 304 may be removably secured to translation stage system 306. Translation stage system 306 includes a microscope carriage 308 that supports and holds microscope 304. Microscope carriage 308 is attached to a slider 310, which attached to translation stage rail 312. As shown, microscope carriage 308 is attached to a motor 314 via a linear rod 316. Motor 314 may actuate linear rod 316 in order to move slider 310 and microscope carriage 308 along translational stage rail 312. An end stop disk and end stop 320 may also be provided.

As motor 314 moves slider 310 along translational stage rail 312 microscope 304 translates in the same direction. Accordingly, the imaging may be improved and adjusted by moving the microscope and imaging device in order to adjust the focal length to a desired, focused setting. In other words, microscope 304 may be moved closer or farther away from particulate matter on a collection surface to ensure that detailed, in-focus images are captured for analysis and identification of airborne particulate matter.

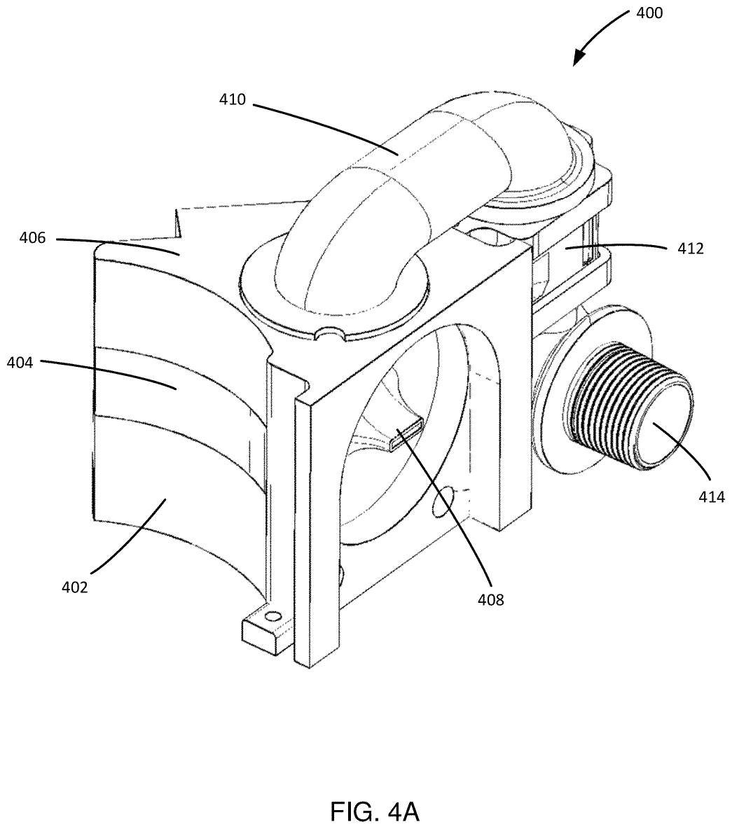

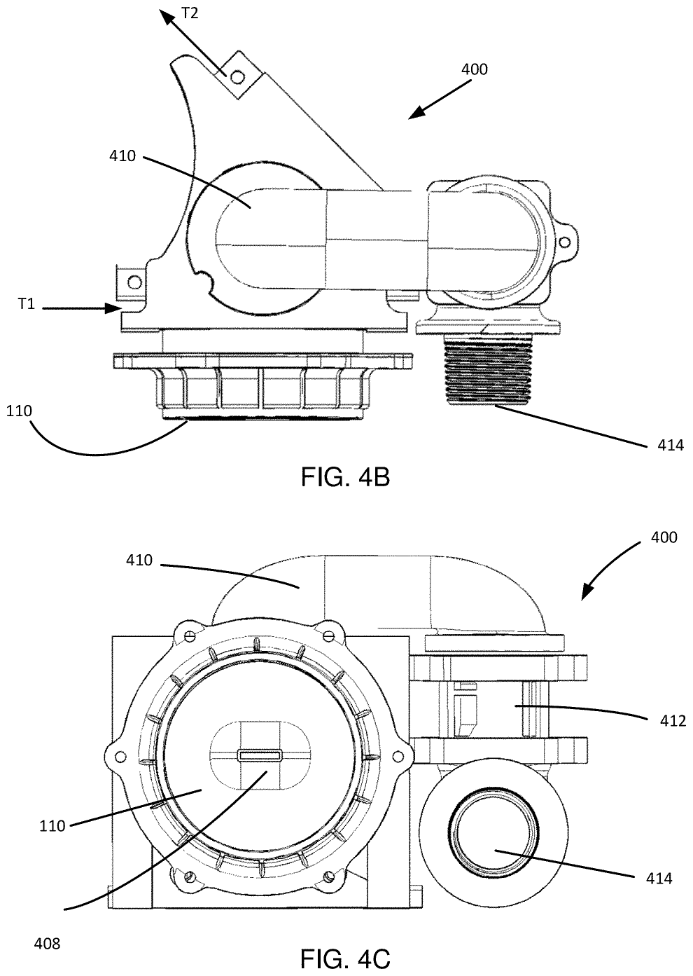

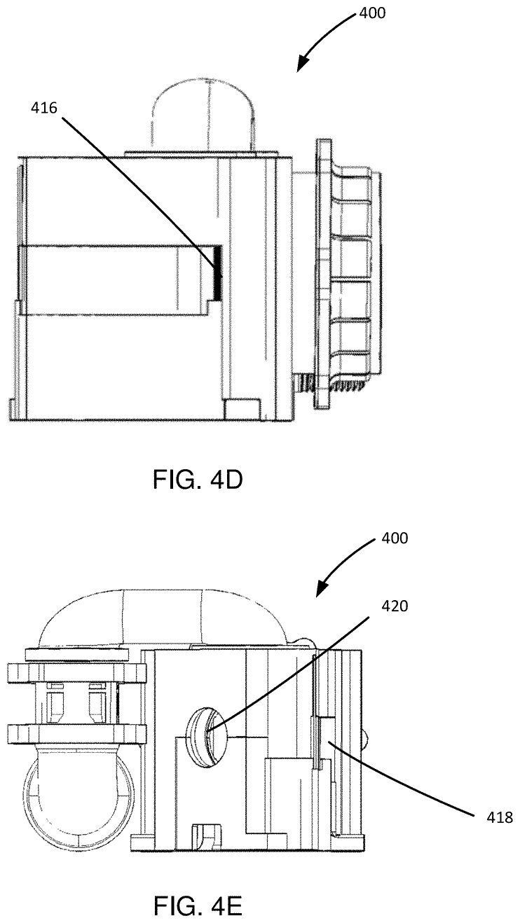

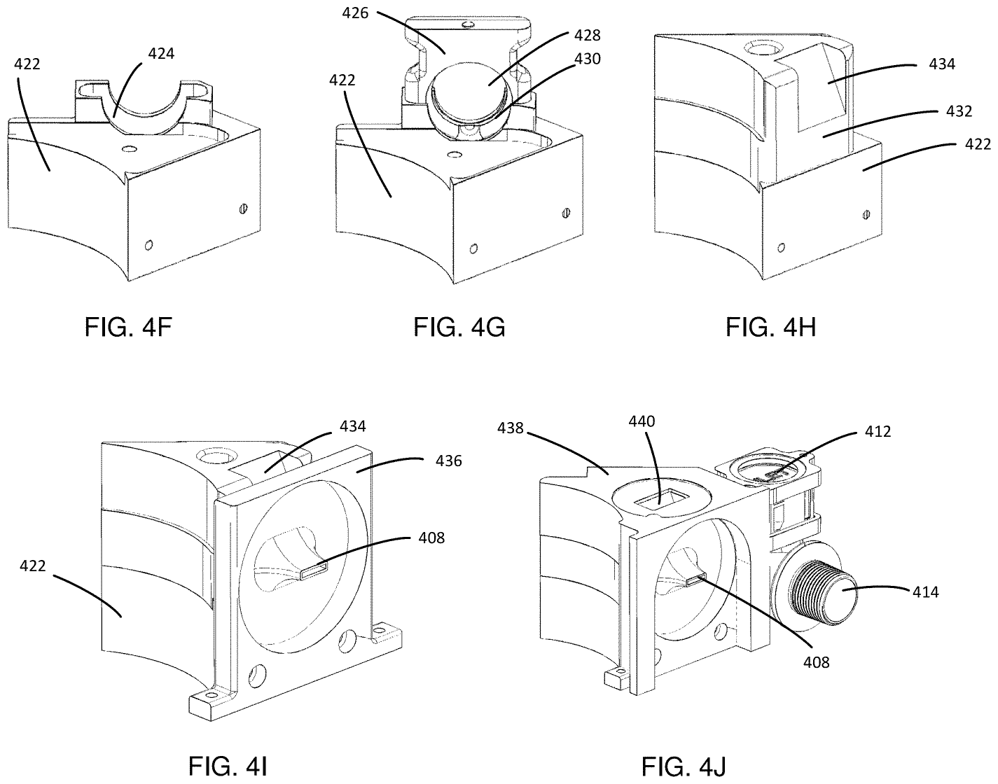

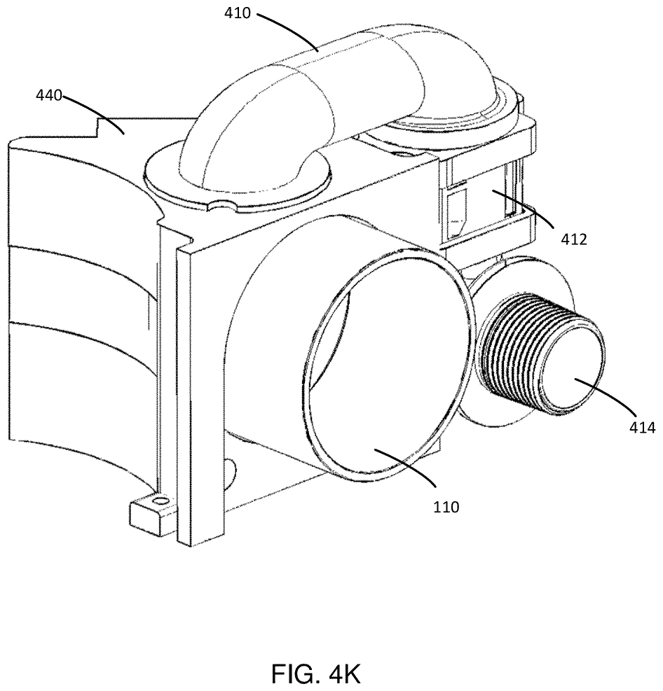

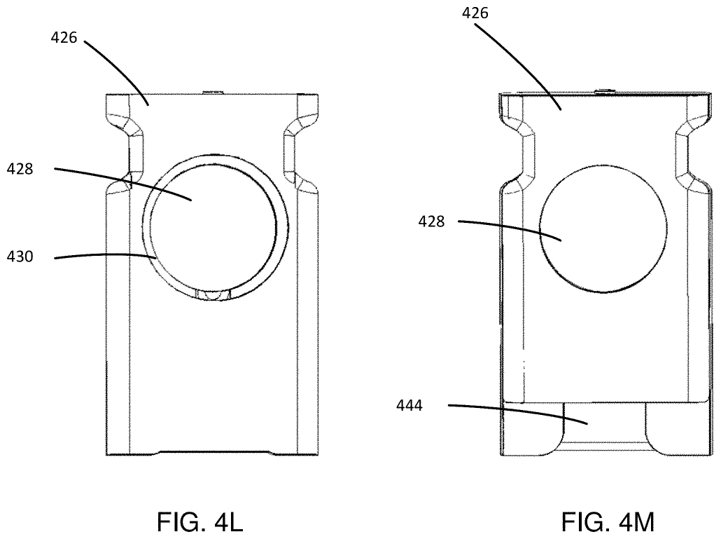

The particle capture chamber subsystem 400 will now be described with reference to FIGS. 4A-4M. As shown in FIG. 4A, particle capture chamber subsystem 400 includes a base member 402, a guide member 404, and a light trap lid 406. Each of these components will be shown and described in more detail below. The particle capture chamber subsystem 400 further includes a nozzle aperture 408, an air pipe 410, a fan 412, and an air exhaust 414.

Nozzle aperture 408 intakes ambient air containing airborne particulate matter into an inner chamber of particle capture chamber subsystem 400. The inner chamber is described further below. The air samples taken in nozzle aperture 408 flow towards into an inner chamber of particle capture chamber subsystem 400. Air samples are continuously drawn in through nozzle aperture 408 and then exhausted. Air drawn in nozzle aperture 408 is caused to flow through air pipe 410 by fan 412 disposed at an end of air pipe 410. Fan 412 then exhausts the air out of air exhaust 414.

FIG. 4B shows a top view of particle capture chamber subsystem 400. As shown in FIG. 4B, ambient air is taken in through air intake aperture 110. As shown in FIG. 4C, nozzle aperture 408 is disposed within the air intake aperture of housing 102. FIG. 4B further shows that collection surface 206 enters into particle capture chamber subsystem 400 in the direction indicated by T1. Collection surface 206 enters particle capture chamber subsystem 400 through a tape inlet 416 shown in FIG. 4D, which is a side view of particle capture chamber subsystem 400. Collection surface 206 is pulled through particle capture chamber subsystem 400 by the driving of uptake spool 202. The air samples taken in nozzle aperture 408 flow towards collection surface 206 within the inner chamber of particle capture chamber subsystem 400. After air passes around collection surface 206 and airborne particulate matter is collected on collection surface 206, air samples are exhausted from particle capture chamber subsystem 400 and air sampling device 100. The air samples are continuously drawn in through nozzle aperture 408, passed over collection surface 206, and then exhausted. Air drawn in nozzle aperture 408 is caused to flow through air pipe 410 by fan 412 disposed at an end of air pipe 410. Fan 412 then exhausts the air out of air exhaust 414.

Collection surface 206 exits particle capture chamber subsystem 400 in a direction indicated by T2 in FIG. 4B. As shown in FIG. 4E, collection surface 206 exits particle capture chamber subsystem 400 through tape outlet 418. Collection surface 206 is then wound up around top wheel 216 of uptake spool 202. FIG. 4E further shows an imaging aperture 420, through which airborne particulate matter collected on collection surface 206 is imaged by imaging subsystem 300. For example, before collection surface 206 exits particle capture chamber subsystem 400, collection surface 206, which has already collected airborne particulate matter, passes imaging aperture 420. As is described below, an end of microscope 304 of imaging subsystem 300 is aligned with imaging aperture 420. As collection surface 206 passes imaging aperture 420 imaging device 302 of imaging subsystem 300 captures an image of the airborne particulate matter collected on collection surface 206.

Each component of particle capture chamber subsystem 400 and how they each fit together will be described with reference to FIGS. 4F-4K. As shown in FIG. 4F, particle capture chamber subsystem 400 includes base member 422. Base member 422 includes an optical cartridge slot 424. As shown in FIG. 4G, optical cartridge 426 fits into optical cartridge slot 424. Optical cartridge 426 is described in more detail below with reference to FIGS. 4L and 4M.

As shown in FIG. 4H, an upper surface of base member 422 receives a guide member 432. Guide member 432 is similar to guide member 208 shown in FIG. 2A. Guide member 432 includes a vent 434, through which air samples are expelled upward toward air pipe 410 and then exhausted out air exhaust 414.

As shown in FIG. 4I, nozzle wall 436, including nozzle aperture 408, is attached to a front surface of base member 422. Nozzle wall 436 is attached to base member 422 in such a way that a gap is left between nozzle wall 436 and guide member 432. The gap between nozzle wall 436 and guide member 432 form the inner chamber where collection surface 206 passes between nozzle aperture 408 and guide member 432. In other words, collection surface 206 passes nozzle aperture 408 and collects airborne particulate matter entering through nozzle aperture 408. Air samples passing around collection surface 206 are then expelled upward through vent 434.

FIG. 4J shows a particle chamber lid 438 that is placed over the top of particle chamber subsystem 400. Particle chamber lid 438 surrounds and completes the inner chamber of particle chamber subsystem 400. As shown, particle chamber lid 438 includes a vent aperture 440. Air samples being expelled through vent 434 pass through vent aperture 440 to enter air pipe 410. The full particle chamber subsystem 400 is shown in FIG. 4K, including air pipe 410 disposed over vent aperture 440 with air pipe 410 extending to fan 412, and air exhaust 414.

Optical cartridge 426 will now be described with reference to FIGS. 4L and 4M. FIG. 4L shows a front side of optical cartridge 426. Or, in other words, FIG. 4L shows a side of optical cartridge 426 that faces towards collection surface 206 as collection surface 206 moves through particle chamber subsystem 400 when optical cartridge 426 is disposed in optical cartridge slot 424. FIG. 4M shows a rear side of optical cartridge 426. Or, in other words, FIG. 4M shows a side of optical cartridge 426 that faces towards imaging subsystem 300 when optical cartridge 426 is disposed in optical cartridge slot 424. As shown in FIGS. 4G and 4L, optical cartridge includes optical aperture 428. When optical cartridge 426 is disposed in optical cartridge slot 424, optical aperture 428 is substantially aligned with imaging aperture 420, thereby providing an opening for imaging subsystem 300 to capture images of collection surface 206 within particle capture chamber subsystem 400.

As further shown in FIG. 4L, optical cartridge 426 may include an optical element 430 disposed to surround optical aperture 428. Optical element 430 may be any suitable optical element for creating or directing light. For example, optical element 430 may be an electromagnetic radiation emitter or light source such as a light ring that emits light/electromagnetic radiation onto collection surface 206. The light source or emitter is not particularly limited and may be any emitter of light/electromagnetic radiation, whether visible or invisible, suitable to emit light onto a surface.

Additionally, more than one light source or emitter may be used. For example, in one contemplated embodiment, imaging subsystem 300 is configured to perform stereometric photography in which the light source may be comprised of at least two photo emitters which may be independently powered. The light source may be configured as an array of photo emitters, wherein each photo emitter may be independently powered in succession, one after another. The camera may simultaneously capture a succession of images, wherein the contrast in each image is determined by the light received by the imaging device from one of the photon emitters being powered independently from the rest of the plurality of the photon emitters. In one example, the light source is configured as a circular array of sixteen light emitting diodes (LEDs), wherein a first LED is powered on, an image is captured by the camera, the first LED is powered off, a second LED is powered on, an image is captured, the second LED is powered off, and this process is followed until sixteen images have been captured by the camera. The plurality of images may then be processed by an electronic device and superimposed to create a rendering of a final composite image, from which further data may be extracted.

Alternatively, optical element 430 may be a reflector, prism, or diffuser that directs or reflects light coming from another source. For example, as shown in FIG. 4M, optical cartridge 426 includes a cavity 444 that may house or hold a light source or electromagnetic radiation emitter. Optical element 430 may be an optical element that focuses, directs, reflects, diffuses, amplifies, or otherwise changes the path or quality of light emitted from a source housed in cavity 444. Note that the light source/electromagnetic emitter may be positioned in positions other than cavity 444 or optical aperture 428. The position of the light source/electromagnetic emitter is not particularly limited by the disclosure.

In the embodiment of air sampling device 100, optical element 430 of optical cartridge 426 is disposed between imaging subsystem 300 and collection surface 206, and optical element 430 emits or directs light onto a portion of collection surface 206 that faces imaging subsystem 300. Accordingly, the configuration shown in the drawings is a front-lit configuration. However, it is to be understood that a back-lit configuration, where collection surface 206 is disposed between optical element 430 and imaging subsystem 300 and optical element 430 emits light onto a back side of collection surface 206, is also within the scope of the disclosure.

Having a light ring or other optical element disposed around optical aperture 428 is advantageous in that it illuminates and directs light over a wide area of collection surface 206 and allows for a wide image of airborne particulate matter to be analyzed and identified.

FIG. 5 shows an illustration of each of collection surface subsystem 200, imaging subsystem 300, and particle chamber subsystem 400 assembled together. Note that the particle chamber lid 438 and air pipe 410 are not included in the illustration for purposes of clarity.

As shown in FIG. 5, collection surface 206 (dotted line) extends between the two spools of collection surface subsystem 200. Collection surface 206 passes through a gap between guide member 404 and nozzle wall 434, or in other words, the inner chamber of particle capture chamber subsystem 400. As collection surface 206 passes adjacent to nozzle aperture 408 through the inner chamber, air containing airborne particulate matter enters through nozzle aperture 408, passes around collection surface 206, and airborne particulate matter is deposited on collection surface 206. As described above, the used air sample is then expelled through vent 434 into air pipe 410, and is then exhausted out air exhaust 414 by fan 412.

Collection surface 206 then wraps around guide member 404, and passes through a gap between optical cartridge 426 and guide member 404. Surfaces of guide member 404 may be prepared with non-stick, friction reducing materials and substances in order to decrease friction and wear on collection surface 206 as collection surface 206 rubs against guide member 404. As collection surface 206 passes through, collection surface 206 is aligned with imaging device 302, microscope 304, imaging aperture 420, and optical aperture 428. In this configuration, imaging device 302 captures images of collection surface 206 and collected airborne particulate matter as collection surface 206 passes.

With particle chamber lid 438 in place, the inner chamber becomes a light block that blocks outside light from entering or exiting the inner chamber, except for light entering and/or exiting through imaging aperture 420. This configuration is advantageous in that it blocks outside light interference and ensures that only imaging light is incident on airborne particulate matter when collection surface 206 is imaged. Accordingly, such a configuration leads to higher quality images and, therefore, more reliable identification and analysis of airborne particulate matter.

As air sampling device 100 operates, air is continuously drawn in and cycled through particle capture chamber subsystem 400 as described above. Furthermore, as air is continuously drawn into particle capture chamber subsystem 400, collection surface 206 is continuously pulled through particle capture chamber subsystem 400 and continuously collects airborne particulate matter. Moreover, imaging device 302 is configured to repeatedly capture multiple still images or video of airborne particulate matter on collection surface 206. Accordingly, the present configuration of air sampling device 100 is configured to provide continuous sampling, continuous imaging, and continuous identification of airborne particulate matter. Advantages of such a configuration include, faster more efficient sampling, the ability to see identify how concentration and composition of airborne particulate matter changes over time, the ability to collect more samples more quickly, and the ability to avoid chemicals and other agents needed to test particulate matter. Furthermore, the use of illuminated/electromagnetic radiation microscopy allows for better identification of more types of airborne particulate matter, as well as the ability to identify visual characteristics of particulate matter, such as size, shape, color, among others. Conventional air sampling devices that depend on light refraction to identify particulate matter cannot identify such characteristics and particulates. Additionally, continuous sampling, collection, and imaging of particulate matter is advantageous over conventional air sampling systems, because continuous sampling, collection, and imaging allows for quicker sampling without the need to reset a sampling device, add new compounds to the device, and/or clean the device between samples.

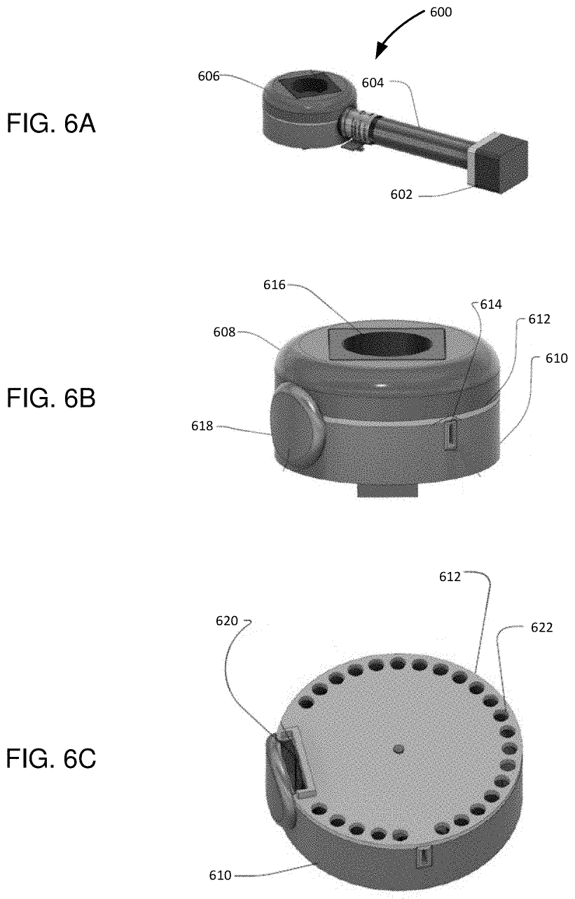

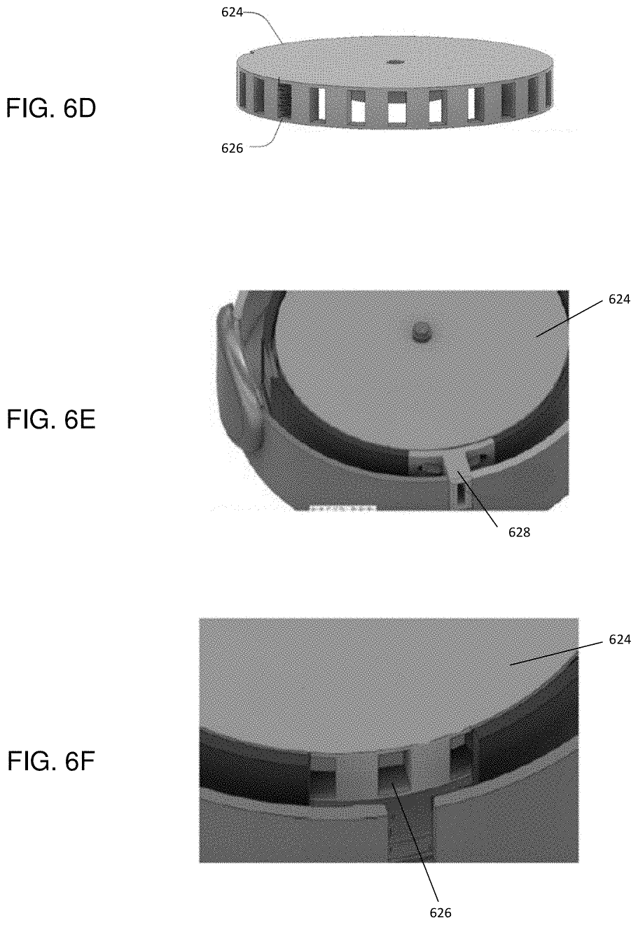

FIGS. 6A-6F illustrate an alternate embodiment of an air sampling device 600. In the alternate embodiment, portable air sampling device 600 comprises an imaging device 602, a microscope 604 and an air sampling unit 606. The imaging device 602 and microscope 604 may be the same as those described with respect to air sampling device 100.

Referring now to FIGS. 6A-6F, air sampling unit 606 may comprise an upper portion 608, a center plate 612, a lower portion 610, an air intake aperture 614, an air exhaust aperture 616, and a view port 618 where the microscope 604 and imaging device 602 view inside air sampling unit 606. Portable air sampling device 600 may further comprise an air sampling reel 624 contained in the air sampling unit 606 (FIG. 6D). The air sampling reel 624 further comprises a single layer of deposition substrate located on an outer circumferential surface, or an inner circumferential surface of the air sampling reel 624. The deposition substrate may be comprised of a transparent adhesive tape or a re-usable transparent substrate. The air sampling reel 624 is configured as a circular wheel having a plurality of apertures 626 configured for determining the area and size of the deposition or imaging area. The air sampling reel 624 is configured to be housed in a portion of the air-sampling unit 606. The air-sampling unit 606 may further comprise a stepper mechanism or motor that turns the air sampling reel 624 within air sampling unit 606. The air intake aperture 614 is configured to align with one aperture 626 of air sampling reel 624 as the air sampling reel 624 rotates in plane.

In an embodiment, air sampling reel 624 may be housed within lower portion 610 of air sampling unit 606, wherein deposition and imaging of particles in a volume of air may occur. The volume of air then flows through apertures 622 located in center plate 612 into upper portion 608 of the air-sampling unit 606, wherein the volume of air leaves air sampling unit 606 via the exhaust outlet 616. It is anticipated that the microscope view port 618 may be sealed off via a cover which may be removably secured to air sampling unit 606.

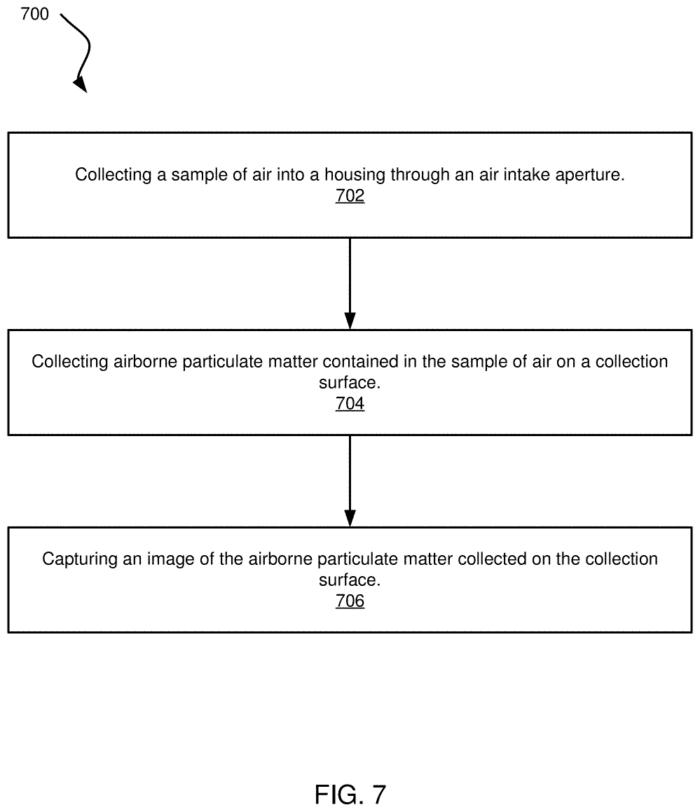

FIG. 7 illustrates a method 700 for collecting and analyzing airborne particulate matter using an air sampling device, such as those described in this disclosure. The method may include a step 702 of collecting a sample of air into a housing through an air intake aperture. The method may further include a step 704 of collecting airborne particulate matter contained in the sample of air on a collection surface. The method may further include a step 706 of capturing an image of the airborne particulate matter collected on the collection surface. Additional steps may be added to the method based on the functions and features of each of the components, elements, devices, and systems described in this disclosure.

Once data and images are collected of airborne particulate matter in air samples, such data can be analyzed by one or more software programs to identify the types, composition, and concentration of airborne particulate matter in an air sample. As shown in FIG. 1, air sampling device 100 may include controller housing 118 that houses a controller for analyzing images and data based on captured samples.

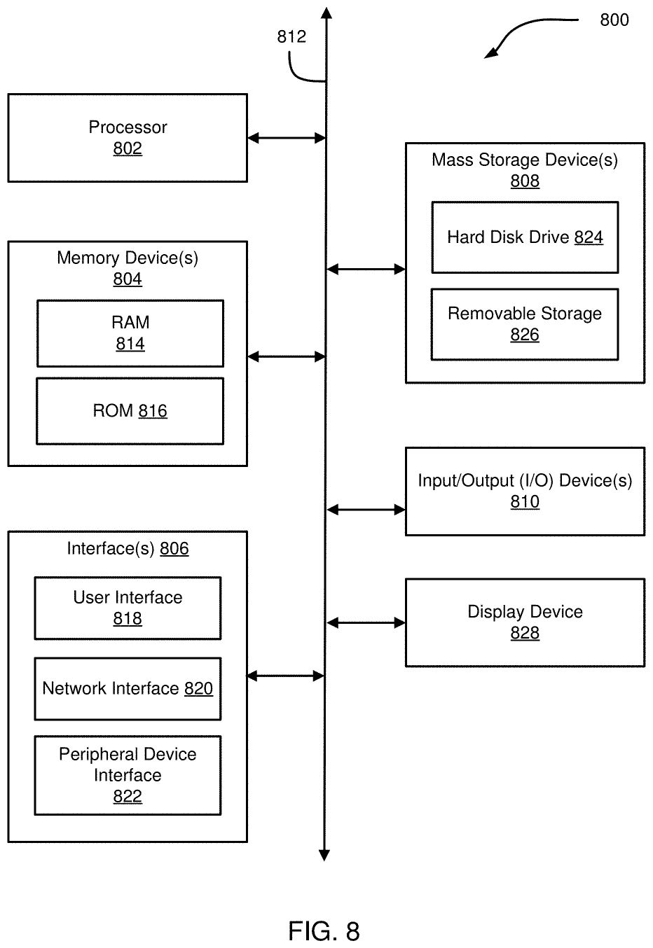

Alternatively, air sampling device 100 may send data via Internet, wired, or wireless connections to an outside computing device for data analysis and storage. An air sampling system may include air sampling device 100 and an outside computing system/controller to analyze the data gathered by air sampling device 100. Whether the data analysis and particulate identification is carried out in a controller in air sampling device 100 or an outside computer, either may include one or more of the components described below and shown in FIG. 8.

FIG. 8 is a schematic diagram of complementary system hardware such as a special purpose or general-purpose computer. Either a controller of air sampling device 100 or an outside computer may perform the function of a special purpose or general-purpose computer. Implementations within the scope of the present disclosure may also include physical and other non-transitory computer readable media for carrying or storing computer executable instructions and/or data structures. Such computer readable media can be any available media that can be accessed by a general purpose or special purpose computer system. Computer readable media that stores computer executable instructions are computer storage media (devices). Computer readable media that carry computer executable instructions are transmission media. Thus, by way of example, and not limitation, implementations of the disclosure can comprise at least two distinctly different kinds of computer readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer executable instructions or data structures and which can be accessed by a general purpose or special purpose computer.

A “network” is defined as one or more data links that enable the transport of electronic data between computer systems and/or modules and/or other electronic devices. In an implementation, a sensor and camera controller may be networked to communicate with each other, and other components, connected over the network to which they are connected. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer executable instructions or data structures and which can be accessed by a general purpose or special purpose computer. Combinations of the above should also be included within the scope of computer readable media.

Further, upon reaching various computer system components, program code means in the form of computer executable instructions or data structures that can be transferred automatically from transmission media to computer storage media (devices) (or vice versa). For example, computer executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered storage, such as FusionIO). Thus, it should be understood that computer storage media (devices) can be included in computer system components that also (or even primarily) utilize transmission media.

Computer executable instructions comprise, for example, instructions and data which, when executed by one or more processors, cause a general-purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, controllers, camera controllers, hand-held devices, hand pieces, multi-processor systems, microprocessor-based or programmable consumer electronics, network PCs, minicomputers, mainframe computers, mobile telephones, PDAs, tablets, pagers, routers, switches, various storage devices, and the like. It should be noted that any of the above-mentioned computing devices may be provided by or located within a brick and mortar location. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) or field programmable gate arrays (FPGAs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

FIG. 8 is a block diagram illustrating an example computing device 800. Computing device 800 may be used to perform various procedures, such as those discussed herein. Computing device 800 can function as a server, a client, or any other computing entity. Computing device 800 can perform various monitoring functions as discussed herein, and can execute one or more application programs, such as the application programs described herein. Computing device 800 can be any of a wide variety of computing devices, such as a desktop computer, a notebook computer, a server computer, a handheld computer, camera controller, tablet computer and the like.

Computing device 800 includes one or more processor(s) 802, one or more memory device(s) 804, one or more interface(s) 806, one or more mass storage device(s) 808, one or more Input/Output (I/O) device(s) 810, and a display device 828 all of which are coupled to a bus 812. Processor(s) 802 include one or more processors or controllers that execute instructions stored in memory device(s) 804 and/or mass storage device(s) 808. Processor(s) 802 may also include various types of computer readable media, such as cache memory.

Memory device(s) 804 include various computer readable media, such as volatile memory (e.g., random access memory (RAM) 814) and/or nonvolatile memory (e.g., read-only memory (ROM) 816). Memory device(s) 804 may also include rewritable ROM, such as Flash memory.

Mass storage device(s) 808 include various computer readable media, such as magnetic tapes, magnetic disks, optical disks, solid-state memory (e.g., Flash memory), and so forth. As shown in FIG. 8, a particular mass storage device is a hard disk drive 824. Various drives may also be included in mass storage device(s) 808 to enable reading from and/or writing to the various computer readable media. Mass storage device(s) 808 include removable media 826 and/or non-removable media.

I/O device(s) 810 include various devices that allow data and/or other information to be input to or retrieved from computing device 800. Example I/O device(s) 810 include digital imaging devices, electromagnetic sensors and emitters, cursor control devices, keyboards, keypads, microphones, monitors or other display devices, speakers, printers, network interface cards, modems, lenses, CCDs or other image capture devices, and the like.

Display device 828 includes any type of device capable of displaying information to one or more users of computing device 800. Examples of display device 828 include a monitor, display terminal, video projection device, and the like.

Interface(s) 806 include various interfaces that allow computing device 800 to interact with other systems, devices, or computing environments. Example interface(s) 806 may include any number of different network interfaces 820, such as interfaces to local area networks (LANs), wide area networks (WANs), wireless networks, and the Internet. Other interface(s) include user interface 818 and peripheral device interface 822. The interface(s) 806 may also include one or more user interface elements 818. The interface(s) 806 may also include one or more peripheral interfaces such as interfaces for printers, pointing devices (mice, track pad, etc.), keyboards, and the like.

Bus 812 allows processor(s) 802, memory device(s) 804, interface(s) 806, mass storage device(s) 808, and I/O device(s) 810 to communicate with one another, as well as other devices or components coupled to bus 812. Bus 812 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 800 and are executed by processor(s) 802. Alternatively, the systems and procedures described herein can be implemented in hardware, or a combination of hardware, software, and/or firmware. For example, one or more application specific integrated circuits (ASICs) or field programmable gate arrays (FPGAs) can be programmed to carry out one or more of the systems and procedures described herein.

### Examples

The following examples pertain to further embodiments.

Example 1 is an air sampling device for collecting and analyzing airborne particulate matter. The air sampling device includes a housing. The air sampling device includes an air intake aperture in the housing where air enters an interior of the housing. The air sampling device includes a collection surface, disposed within the housing, that captures airborne particulate matter contained in the air. The system includes an imaging device that captures an image of the airborne particulate matter collected on the collection surface.

Example 2 is an air sampling device as in Example 1 further comprising a microscope for viewing the airborne particulate matter collected on the collection surface. The air sampling device is configured such that the imaging device views and captures an image of the airborne particulate matter collected on the collection surface through the microscope.

Example 3 is an air sampling device as in Examples 1-2, wherein the collection surface captures the airborne particulate matter using electrostatic attraction between the collection surface and the airborne particulate matter.

Example 4 is an air sampling device as in Examples 1-3, wherein the collection surface captures the airborne particulate matter using an adhesive material on the collection surface.

Example 5 is an air sampling device as in Examples 1-4, wherein the collection surface comprises a flexible tape.

Example 6 is an air sampling device as in Examples 1-5 further comprising an emitter that emits light onto the collection surface at a point of image capture.

Example 7 is an air sampling device as in Examples 1-6, wherein the collection surface is back-lit relative to a surface of the collection surface that faces the imaging device.

Example 8 is an air sampling device as in Examples 1-7, wherein the collection surface is front-lit relative to a surface of the collection surface that faces the imaging device.

Example 9 is an air sampling device as in Examples 1-8, wherein the emitter emits light onto the collection surface via a reflector that directs light emitted from the emitter onto the collection surface.

Example 10 is an air sampling device as in Examples 1-9, further comprising a feed spool and an uptake spool. The collection surface is wound around the feed spool and extends from the feed spool to the uptake spool. As the collection surface is fed out from the feed spool, the collection surface passes the air intake aperture, collects airborne particulate matter entering through the air intake aperture, and is wound up around the uptake spool, and, as the collection surface travels from the feed spool to the uptake spool, an image of the airborne particulate matter captured on a portion of the collection surface disposed between the feed spool and the uptake spool is captured.

Example 11 is an air sampling device as in Examples 1-10, wherein the collection surface continually collects airborne particulate matter along a length of the flexible tape as the collection surface moves from the feed spool to the uptake spool.

Example 12 is an air sampling device as in Examples 1-11, wherein the imaging device repeatedly captures images of the collection surface and airborne particulate matter as the collection surface moves from the feed spool to the uptake spool.

Example 13 is an air sampling device as in Examples 1-12, further comprising a particle capture chamber disposed within the housing. The particle capture chamber comprises a chamber housing, a tape inlet aperture that is formed in the wall of the chamber housing and allows the collection surface to pass through the chamber housing, and a nozzle aperture that is formed in the wall of the chamber housing and is in fluid communication with the air intake aperture such that air entering the housing through the air intake aperture enters the particle capture chamber through the nozzle aperture. The collection surface passes through the particle capture chamber at a position adjacent to the nozzle aperture and collects airborne particulate matter entering the particle capture chamber through the nozzle aperture.

Example 14 is an air sampling device as in Examples 1-13, wherein the particle capture chamber further comprises: an air pipe through which air leaves the particle capture chamber; a fan that drives air through the air pipe; and an air exhaust port through which air traveling through the air pipe is expelled to an outside of the housing by the fan.

Example 15 is an air sampling device as in Examples 1-14, wherein the particle capture chamber further comprises an imaging aperture disposed at a position downstream from the nozzle aperture with respect to a travel direction of the collection surface that allows the imaging device to image the collection surface and the airborne particulate matter while the collection surface is inside the particle capture chamber.

Example 16 is an air sampling device as in Examples 1-15, wherein the microscope is mounted to a translation stage for adjusting a position of the microscope to adjust the focal length.

Example 17 is an air sampling device as in Examples 1-16, further comprising an air sampling reel disposed within the housing and comprising a layer of a deposition substrate disposed on a surface of the air sampling reel as the collection surface, wherein the air sampling reel is a circular wheel having a plurality of collection apertures that expose the collection surface to airborne particulate matter at a plurality of locations.

Example 18 is an air sampling device as in Examples 1-17, further comprising a microscope access aperture disposed at a location that allows the imaging device to view, through the microscope, at least one of the plurality of collection apertures on the air sampling reel.

Example 19 is an air sampling device as in Examples 1-18, wherein the air sampling reel is rotatable within the housing such that, as the air sampling reel rotates, each of the plurality of collection apertures are sequentially rotated into a position opposite the imaging device, allowing each of the plurality of collection apertures and corresponding collection surface to be imaged by the imaging device.

Example 20 is an air sampling system for collecting airborne particulate matter, the air sampling system comprising an air sampling device, such as any of Examples 1-19, and a controller in electronic communication with the air sampling device. For example, the air sampling device includes a housing. The air sampling device includes an air intake aperture in the housing where air enters an interior of the housing. The air sampling device includes a collection surface, disposed within the housing, that captures airborne particulate matter contained in the air. The system includes an imaging device that captures an image of the airborne particulate matter collected on the collection surface.

Example 21 is a method collecting airborne particulate matter using an air sampling device or system, such as any of Examples 1-20. For example, the air sampling device includes a housing. The air sampling device includes an air intake aperture in the housing where air enters an interior of the housing. The air sampling device includes a collection surface, disposed within the housing, that captures airborne particulate matter contained in the air. The system includes an imaging device that captures an image of the airborne particulate matter collected on the collection surface. The method comprises steps of collecting a sample of air into the housing through the air intake aperture; collecting airborne particulate matter contained in the sample of air on the collection surface; and capturing an image of the airborne particulate matter collected on the collection surface.

It will be appreciated that various features disclosed herein provide significant advantages and advancements in the art. The following claims are exemplary of some of those features.

In the foregoing Detailed Description of the Disclosure, various features of the disclosure are grouped together in a single embodiment for the purpose of streamlining the disclosure. This method of disclosure is not to be interpreted as reflecting an intention that the claimed disclosure requires more features than are expressly recited in each claim. Rather, inventive aspects lie in less than all features of a single foregoing disclosed embodiment.

It is to be understood that any features of the above-described arrangements, examples, and embodiments may be combined in a single embodiment comprising a combination of features taken from any of the disclosed arrangements, examples, and embodiments.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements.

Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

Further, where appropriate, functions described herein can be performed in one or more of: hardware, software, firmware, digital components, or analog components. For example, one or more application specific integrated circuits (ASICs) or field programmable gate arrays (FPGAs) can be programmed to carry out one or more of the systems and procedures described herein. Certain terms are used throughout the following description and claims to refer to particular system components. As one skilled in the art will appreciate, components may be referred to by different names. This document does not intend to distinguish between components that differ in name, but not function.

The foregoing description has been presented for the purposes of illustration and description. It is not intended to be exhaustive or to limit the disclosure to the precise form disclosed. Many modifications and variations are possible in light of the above teaching. Further, it should be noted that any or all the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. An air sampling device for collecting and analyzing airborne particulate matter, the air sampling device comprising:
a housing;
an air intake aperture in the housing where air enters an interior of the housing;
a collection surface, disposed within the housing, that captures airborne particulate matter contained in the air; and
an imaging device that captures an image of the airborne particulate matter collected on the collection surface.

2. The air sampling device of claim 1, further comprising:
a microscope for viewing the airborne particulate matter collected on the collection surface; wherein the imaging device views and captures an image of the airborne particulate matter collected on the collection surface through the microscope.

3. The air sampling device of claim 1, wherein the collection surface captures the airborne particulate matter using electrostatic attraction between the collection surface and the airborne particulate matter.

4. The air sampling device of claim 1, wherein the collection surface captures the airborne particulate matter using an adhesive material on the collection surface.

5. The air sampling device of claim 1, wherein the collection surface comprises a flexible tape.

6. The air sampling device of claim 1, further comprising:
an emitter that emits light onto the collection surface at a point of image capture.

7. The air sampling device of claim 6, wherein the collection surface is back-lit relative to a surface of the collection surface that faces the imaging device.

8. The air sampling device of claim 6, wherein the collection surface is front-lit relative to a surface of the collection surface that faces the imaging device.

9. The air sampling device of claim 6, wherein the emitter emits light onto the collection surface via a reflector that directs light emitted from the emitter onto the collection surface.

10. The air sampling device of claim 5, further comprising:
a feed spool; and
an uptake spool;
wherein the collection surface is wound around the feed spool and extends from the feed spool to the uptake spool;
wherein, as the collection surface is fed out from the feed spool, the collection surface passes the air intake aperture, collects airborne particulate matter entering through the air intake aperture, and is wound up around the uptake spool; and
wherein, as the collection surface travels from the feed spool to the uptake spool, an image of the airborne particulate matter captured on a portion of the collection surface disposed between the feed spool and the uptake spool is captured.

11. The air sampling device of claim 10, wherein the collection surface continually collects airborne particulate matter along a length of the flexible tape as the collection surface moves from the feed spool to the uptake spool.

12. The air sampling device of claim 11, wherein the imaging device repeatedly captures images of the collection surface and airborne particulate matter as the collection surface moves from the feed spool to the uptake spool.

13. The air sampling device of claim 10, further comprising:
a particle capture chamber disposed within the housing, the particle capture chamber comprising:
a chamber housing;
a tape inlet aperture that is formed in the wall of the chamber housing and allows the collection surface to pass through the chamber housing;
a nozzle aperture that is formed in the wall of the chamber housing and is in fluid communication with the air intake aperture such that air entering the housing through the air intake aperture enters the particle capture chamber through the nozzle aperture;
wherein the collection surface passes through the particle capture chamber at a position adjacent to the nozzle aperture and collects airborne particulate matter entering the particle capture chamber through the nozzle aperture.

14. The air sampling device of claim 13, wherein the particle capture chamber further comprises:
an air pipe through which air leaves the particle capture chamber;
a fan that drives air through the air pipe;
an air exhaust port through which air traveling through the air pipe is expelled to an outside of the housing by the fan.

15. The air sampling device of claim 13, wherein the particle capture chamber further comprises:
an imaging aperture disposed at a position downstream from the nozzle aperture with respect to a travel direction of the collection surface that allows the imaging device to image the collection surface and the airborne particulate matter while the collection surface is inside the particle capture chamber.

16. The air sampling device of claim 2, wherein the microscope is mounted to a translation stage for adjusting a position of the microscope to adjust the focal length.

17. The air sampling device of claim 2, further comprising:
an air sampling reel disposed within the housing and comprising a layer of a deposition substrate disposed on a surface of the air sampling reel as the collection surface.
wherein the air sampling reel is a circular wheel having a plurality of collection apertures that expose the collection surface to airborne particulate matter at a plurality of locations.

18. The air sampling device of claim 17, further comprising:
a microscope access aperture disposed at a location that allows the imaging device to view, through the microscope, at least one of the plurality of collection apertures on the air sampling reel.

19. The air sampling device of claim 18, wherein the air sampling reel is rotatable within the housing such that, as the air sampling reel rotates, each of the plurality of collection apertures are sequentially rotated into a position opposite the imaging device, allowing each of the plurality of collection apertures and corresponding collection surface to be imaged by the imaging device.

20. An air sampling system for collecting and analyzing airborne particulate matter, the air sampling system comprising:
an air sampling device comprising:
a housing;
an air intake aperture in the housing where air enters an interior of the housing;
a collection surface, disposed within the housing, that captures airborne particulate matter contained in the air; and
an imaging device that captures an image of the airborne particulate matter collected on the collection surface; and
a controller in electronic communication with the air sampling device.

21. A method of collecting and analyzing airborne particulate matter using an air sampling device comprising:
a housing;
an air intake aperture in the housing where air enters an interior of the housing;
a collection surface, disposed within the housing, that captures airborne particulate matter contained in the air; and
an imaging device that captures an image of the airborne particulate matter collected on the collection surface;
the method comprising steps of:
collecting a sample of air into the housing through the air intake aperture;
collecting airborne particulate matter contained in the sample of air on the collection surface; and
capturing an image of the airborne particulate matter collected on the collection surface.
